(19) United States
(12) Patent Application Publication
(10) Pub. No.: US 2006/0143319 A1
(43) Pub. Date: Jun. 29, 2006

(54) METHOD OF ESTABLISHING COMMUNICATION BETWEEN A USB DEVICE AND A HOST

(76) Inventors: Hung-Yuan Hsu, Hsin-Chu Hsien (TW); Shih-Feng Huang, Hsin-Chu Hsien (TW); Chien-Hsing Hsieh, Hsin-Chu Hsien (TW); Ching-Lin Chung, Hsin-Chu Hsien (TW); Guo-Yuan Ma, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/161,989

(22) Filed: Aug. 25, 2005

(30) Foreign Application Priority Data
Dec. 29, 2004 (TW) 093141210

(51) Int. Cl. G06F 3/00

(52) U.S. Cl. 710/8

(57) ABSTRACT

A method for establishing communication between a USB having a first memory device and a second memory device and a host includes reading first USB identification data stored in the first memory device, determining if the USB device can communicate with the host based on the first USB identification data, and reading second USB identification data stored in the second memory device for establishing communication between the USB device and the host if the USB device cannot communicate with the host based on the first USB identification data.

### BACKGROUND OF THE INVENTION

1. Field of the Invention

The present invention related to a method of establishing communication between a USB device and a host, and more particularly, to a method of establishing communication between a USB device having a first memory device and a second memory device and a host.

2. Description of the Prior Art

The universal serial bus (USB) has become standard equipment in personal computers, and almost all computers provide more than one USB connecting port. The USB standard is characterized by the convenience of plug-and-play, the feature of hot attach and detach, expandability, simple installation, and high transmission rate. These advantages guarantee the nearly omnipresent availability of USB on personal computers, as well as in other products such as scanners, printers and modems. Other products providing USB interfaces, such as digital cameras, external storage devices, portable hard discs, and electrically erasable and programmable read-only memory (EEPROM), are also widely available.

Peripheral devices having USB interfaces are still controlled by a host. When the host detects the presence of a new peripheral device with a USB interface, it creates a virtual pipe for communication, and starts a bus enumeration operation on the USB device. First, the host gives the USB device a “GET_DESCRIPTOR” command, requiring identification information from the USB device. Then the USB device sends the host its identification data including product identification (PID), vendor identification (VID), module type, method of transmission, maximum packet size and bandwidth. Once the host receives the identification data of the USB device, it automatically searches for programs capable of driving the USB device and performs adequate configurations of the drive program. Therefore, whether the USB device can function normally depends on whether the host can receive the correct identification data of the USB device.

Please refer to FIG. 1 for a diagram illustrating a prior art USB device 20 and a host 10. When the USB device 20 is operating in default mode, the USB device 20 sends its USB identification data stored in memory 14 to the host 10. Under this circumstance, the host identifies the USB device 20 as a USB device operating in default mode.

Please refer to FIG. 2 for a diagram illustrating another prior art USB device 45 and the host 10. The USB device 45 includes an input/output pad (I/O pad) 16, a circuit board 18, a multiplexer 24, a USB chip 30, a first memory device 12, and a second memory device 22. Through the I/O pad 16 control signals are sent to the multiplexer 24, which controls data sent from the USB device 45 to the host 10. In order for the host 10 to detect the first memory device 12 of the USB device 45, first USB identification data corresponding to the first memory device 12 has to be written into the first memory device 12 by a universal writer in advance.

When the host 10 detects the USB device 45, it issues a “GET_DESCRIPTOR” command. If the I/O pad 16 sends a control signal of “0”, the USB device 45 replies the “GET_DESCRIPTOR” command with second USB identification data stored in the second memory device 22, so that the host 10 identifies the USB device 45 as operating in default mode. If the I/O pad 16 sends a control signal of “1”, the USB device 45 replies the “GET_DESCRIPTOR” command with the first USB identification data stored in the first memory device 12, so that the host 10 can detect the first memory device 12 of the USB device 45.

Please refer to FIG. 3 for a flowchart illustrating a prior art method for establishing communication between the USB device 45 and the host 10. The flowchart shown in FIG. 3 includes the following steps:

Step 300: write the first USB identification data into the first memory device 12 with a universal writer controlled by computer software;

Step 310: dispose the first memory device 12 on the circuit board 18;

Step 320: send a control signal of “1” through the I/O pad 16;

Step 330: couple the USB device 45 to the host 10;

Step 340: issue a “GET_DESCRIPTOR” command to the USB device 45 from the host 10; and

Step 350: send the first identification data stored in the first memory device 12 to the host 10 for allowing the host 10 to detect the first memory device 12 of the USB device 45.

For the host 10 to detect the first memory device 12 of the USB device 45, extra effort is required for writing the first USB identification data into the first memory device 12 with the universal writer controlled by computer software before disposing the first memory device 12 on the circuit board 18. The prior art method is not only time and effort-consuming, but it also increases manufacturing costs and complicates the process control.

Please refer to FIG. 4 for a flowchart illustrating another prior art method for establishing communication between the USB device 45 and the host 10. The flowchart shown in FIG. 4 includes the following steps:

Step 400: dispose the first memory device 12 on the circuit board 18;

Step 410: send a control signal of “0” through the I/O pad 16;

Step 420: couple the USB device 45 to the host 10; [Para 21]Step 430: issue a “GET_DESCRIPTOR” command to the USB device 45 from the host 10;

Step 440: send a control signal of “1” through the I/O pad 16;

Step 450: write the first USB identification data into the first memory device 12 using computer software installed in the host 10;

Step 460: re-couple the USB device 45 to the host 10;

Step 470: issue a “GET_DESCRIPTOR” command to the USB device 45 from the host 10;

Step 480: send the first identification data stored in the first memory device 12 to the host 10.

The prior art method shown in FIG. 4 does not require a universal writer for writing the first USB identification data into the first memory device 12, but it requires sending control signals through the I/O pad 16 to the multiplexer 24 for controlling the writing and reading operations between the host 10 and the USB device 45. During mass production, the I/O pad 16 is controlled manually. Hence, extra manpower is required and human operational mistakes are also inevitable.

### SUMMARY OF THE INVENTION

It is therefore a primary objective of the claimed invention to provide a method of establishing communication between a USB device and a host in order to solve the problems of the prior art.

The claimed invention provides a method of establishing communication between a USB device having a first memory device and a second memory device and a host comprising: (a) reading first USB identification data stored in the first memory device, (b) determining if the USB device can communicate with the host based on the first USB identification data read in step (a), and (c) if the USB device cannot communicate with the host based on the first USB identification data read in step (a), reading second USB identification data stored in the second memory device for establishing communication between the USB device and the host.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a prior art USB device and a host.

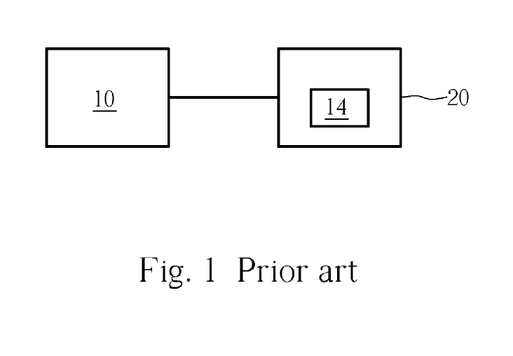

FIG. 2 shows another prior art USB device and a host.

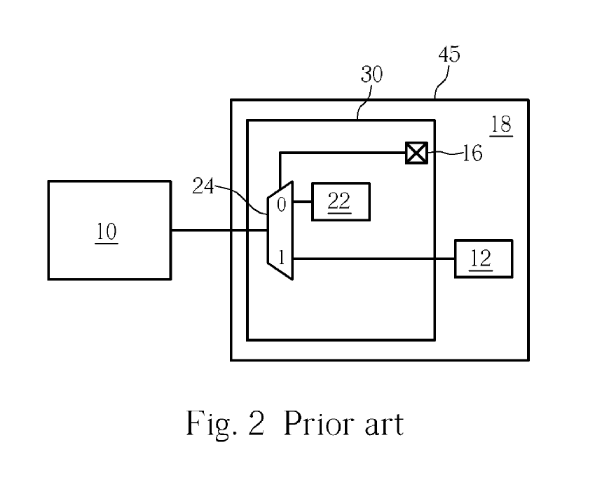

FIG. 3 is a flowchart illustrating a prior art method for establishing communication between the USB device and the host in FIG. 2.

FIG. 4 is a flowchart illustrating another prior art method for establishing communication between the USB device and the host in FIG. 2.

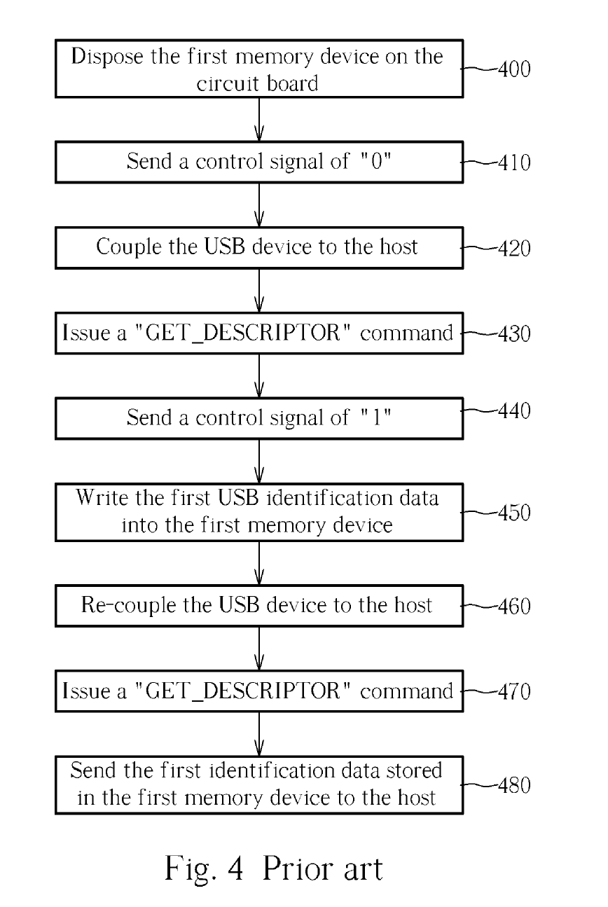

FIG. 5 shows a USB device and a host according to a first embodiment of the present invention.

FIG. 6 is a flowchart illustrating a method for establishing communication between the USB device and the host in FIG. 5.

FIG. 7 shows a USB device and a host according to a second embodiment of the present invention.

FIG. 8 is a flowchart illustrating a method for establishing communication between the USB device and the host in FIG. 7.

### DETAILED DESCRIPTION

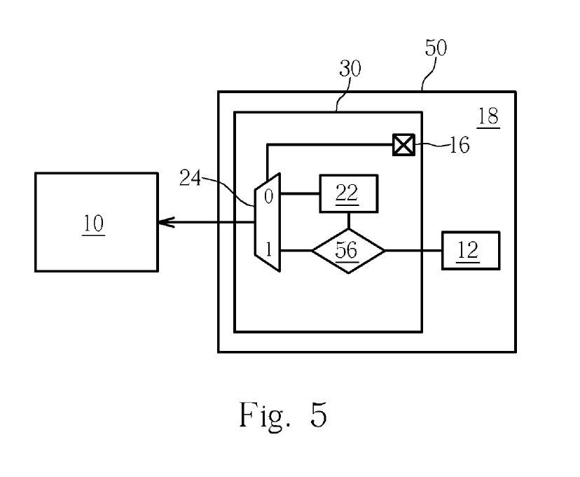

Please refer to FIG. 5 for a diagram illustrating a USB device 50 and the host 10 according to a first embodiment of the present invention. The USB device 50 includes an I/O pad 16, a circuit board 18, a multiplexer 24, a USB chip 30, a first memory device 12, a second memory device 22, and a comparator 56. Through the I/O pad 16 control signals are sent to the multiplexer 24, which controls data sent from the USB device 50 to the host 10. The second memory device 22 includes second identification data corresponding to the USB chip 30, and the first memory device 12 can include first identification data corresponding to the first memory device 12 or other data. If the first identification data is stored in the first memory device 12, then the USB device 50 and the host 10 can communicate with each other based on the first identification data, and the host 10 can detect the first memory device 12 of the USB device 50. The first memory device 12 can be non-volatile memory or electrically erasable and programmable read-only memory (EEPROM).

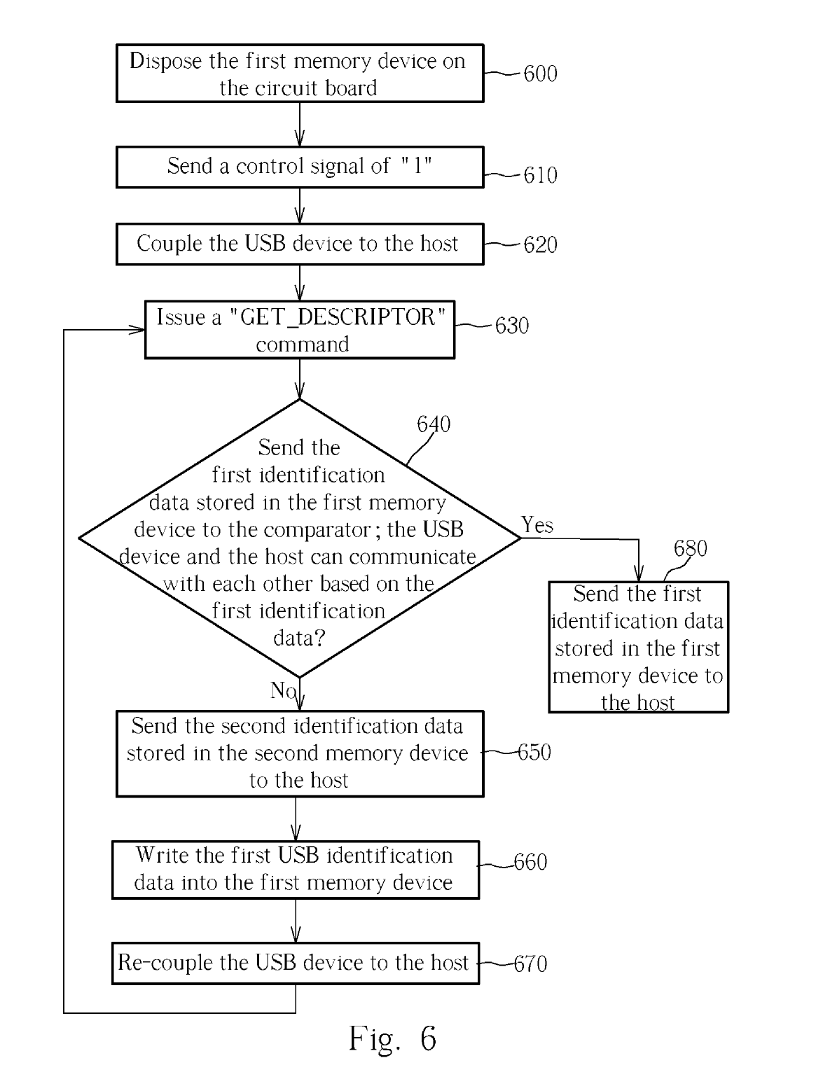

Please refer to FIG. 6 for a flowchart illustrating a method for establishing communication between the USB device 50 and the host 10 according to the first embodiment of present invention. The flowchart shown in FIG. 6 includes the following steps:

Step 600: dispose the first memory device 12 on the circuit board 18;

Step 610: send a control signal of “1” through the I/O pad 16;

Step 620: couple the USB device 50 to the host 10;

Step 630: issue a “GET_DESCRIPTOR” command to the USB device 50 from the host 10;

Step 640: send the first identification data stored in the first memory device 12 to the comparator 56; if the USB device 50 and the host 10 can communicate with each other based on the first identification data, execute step 680; if the USB device 50 and the host 10 cannot communicate with each other based on the first identification data, execute step 650;

Step 650: send the second identification data stored in the second memory device 22 to the host 10 through the comparator 56;

Step 660: write the first USB identification data into the first memory device 12 using computer software installed in the host 10;

Step 670: re-couple the USB device 50 to the host 10; execute step 630; and

Step 680: send the first identification data stored in the first memory device 12 from the USB device 50 to the host 10.

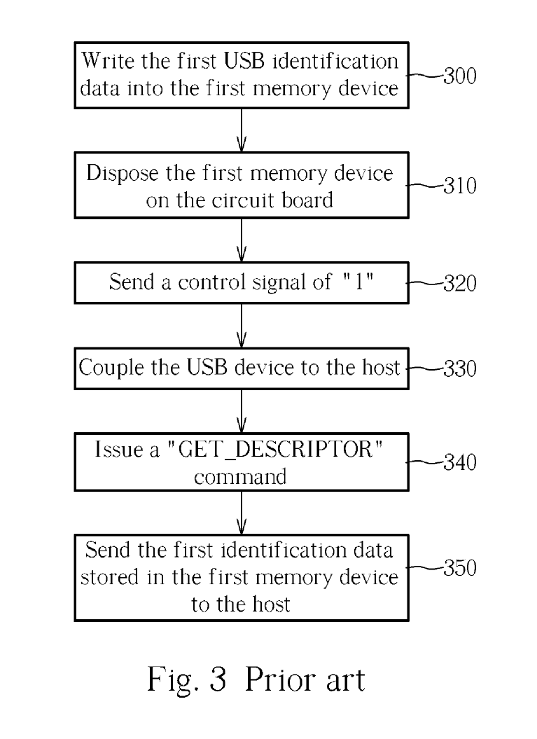

The first embodiment of the present invention does not require a universal writer for writing the first USB identification data into the first memory device 12, and thus has lower manufacturing cost and easier process control than the prior art method shown in FIG. 3. Also, the first embodiment of the present invention excludes the manual control of the I/O pad 16 and hence reduces required manpower and human operational mistakes.

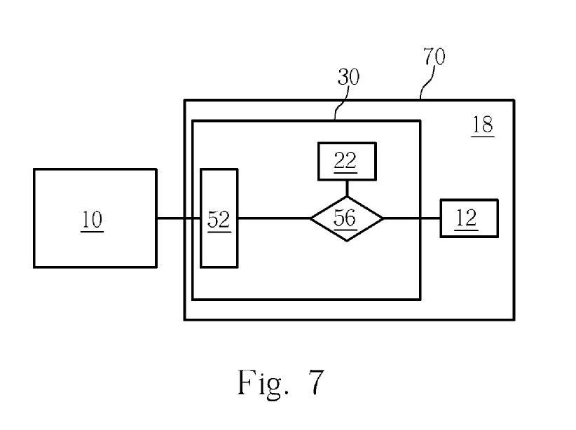

Please refer to FIG. 7 for a diagram illustrating a USB device 70 and the host 10 according to a second embodiment of the present invention. The USB device 70 includes a first memory device 12, a second memory device 22, a USB chip 30, a USB interface 52, and comparator 56. The second memory device 22 includes second identification data, and the first memory device 12 can include first identification data corresponding to the first memory device or other data. If the first identification data is stored in the first memory device 12, then the USB device 70 and the host 10 can communicate with each other based on the first identification data, and the host 10 can detect the first memory device 12 of the USB device 70. The first memory device 12 can be non-volatile memory or EEPROM.

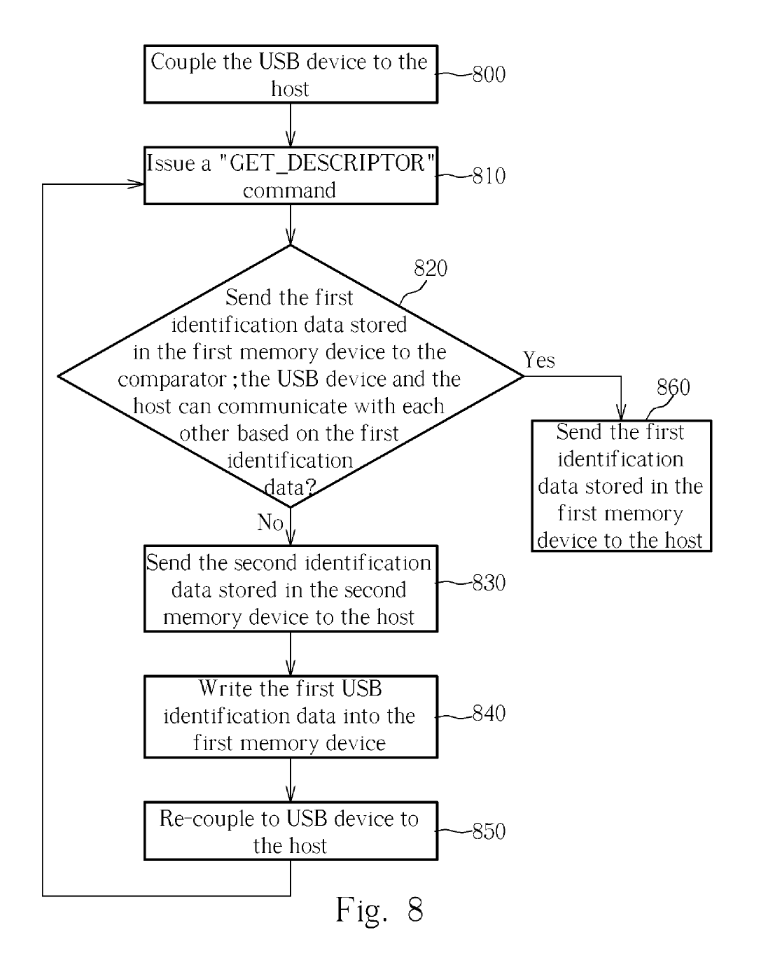

Please refer to FIG. 8 for a flowchart illustrating a method for establishing communication between the USB device 70 and the host 10 according to the second embodiment of present invention. The flowchart shown in FIG. 8 includes the following steps:

Step 800: couple the USB device 70 to the host 10;

Step 810: issue a “GET_DESCRIPTOR” command to the USB device 70 from the host 10;

Step 820: send the first identification data stored in the first memory device 12 to the comparator 56; if the USB device 70 and the host 10 can communicate with each other based on the first identification data, execute step 860; if the USB device 70 and the host 10 cannot communicate with each other based on the first identification data, execute step 830;

Step 830: send the second identification data stored in the second memory device 22 to the host 10 through the comparator 56;

Step 840: write the first USB identification data into the first memory device 12 using computer software installed in the host 10;

Step 850: re-couple the USB device 70 to the host 10; execute step 810; and

Step 860: send the first identification data stored in the first memory device 12 from the USB device 70 to the host 10.

The USB device 50 improves the communication between the USB device and the host based on the structure of the prior art USB device 45. Since the control signal sent through the I/O pad 16 is constantly “1”, the USB device 50 does not necessarily need to include the multiplexer 24. The USB device 70 differs from the USB device 50 in that the USB device 70 integrates the function of the multiplexer 24 into the comparator 56 and further simplifies the manufacturing process.

The present invention does not require a universal writer for writing the first USB identification data into the first memory device 12, and thus has lower manufacturing cost and easier process control than the prior art method shown in FIG. 3. Also, the present invention excludes manual control of the I/O pad 16 and hence reduces required manpower and human operational mistakes. Compared to the prior art methods, the present invention only requires a simple logic circuit for comparing the USB identification data, and writing the required USB identification data into the first memory device quickly. The present invention can reduce manufacturing costs and simplify manufacturing processes during mass production.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of establishing communication between a universal serial bus (USB) device having a first memory device and a second memory device and a host, the method comprising the following steps:
(a) reading first USB identification data stored in the first memory device;
(b) determining if the USB device can communicate with the host based on the first USB identification data read in step (a); and
(c) if the USB device cannot communicate with the host based on the first USB identification data read in step (a), reading second USB identification data stored in the second memory device for establishing communication between the USB device and the host.

2. The method of claim 1 wherein the first USB identification data is written into the first memory device from the host.

3. The method of claim 1 wherein the first memory device is non-volatile memory.

4. The method of claim 1 wherein the first memory device is EEPROM (Electrically Erasable and Programmable Read-Only Memory).

5. The method of claim 1 wherein the first USB identification data and the second USB identification data is outputted to the host through a USB interface.
